(19) United States
(12) Patent Application Publication
(10) Pub. No.: US 2013/0334424 A1
(43) Pub. Date: Dec. 19, 2013

(54) NIGHT VISION SYSTEM FOR A MOTOR VEHICLE

(71) Applicant: GM GLOBAL TECHNOLOGY OPERATIONS LLC, Detroit, MI (US)

(72) Inventors: Frank LANGKABEL, Ruesselsheim (DE); Ingolf SCHNEIDER, Ruesselsheim (DE); Philipp ROECKL, Aschaffenburg (DE)

(21) Appl. No.: 13/911,411

(22) Filed: Jun. 6, 2013

(30) Foreign Application Priority Data
Jun. 14, 2012 (DE) 10 2012 011 847.3

(51) Int. Cl. F21S 8/10

(52) U.S. Cl. CPC F21S 48/115
USPC 250/347; 250/351

(57) ABSTRACT

A night vision system for a motor vehicle is provided. The night vision system includes an infrared-light-emitting LED assembly. The infrared-light-emitting LED assembly is adapted to emit a bundled infrared beam and has a deflecting means for periodically moving the infrared beam through a predefined solid angle range. The night vision system further includes a sensor responsive in a wavelength range of the infrared beam.

### CROSS-REFERENCE TO RELATED APPLICATION

This disclosure claims priority to German Patent Application No. 10 2012 011 847.3, filed Jun. 14, 2012, which is incorporated herein by reference in its entirety.

### TECHNICAL FIELD

The technical field relates to a night vision system for use in a motor vehicle.

### BACKGROUND

Night vision systems in general are based on recording infrared radiation not visible to the human eye and converting it into an image visible to the observer. Passive night vision systems based on the recording of infrared radiation existing in the environment suffer from the problem that the infrared image of scenery differs considerably from the natural image in visible light and is difficult to evaluate by an inexperienced observer. If, for example, such a night vision system is directed at a motor vehicle, warm parts of the motor vehicle such as head lights and exhaust are easy to recognize, whilst body parts with a temperature not markedly different from the environment hardly show up against the background. In order to use an infrared system for generating a picture, which is similar to familiar perception, such a system has to comprise a separate infrared light source with which objects to be recorded can be illuminated.

A night vision system with an infrared light source is, for example, known from the DE 103 48 117 A1.

The infrared light irradiated by the LEDs of this conventional night vision system is not consciously perceived by the human eye. An observer can look frontally at the infrared light source without feeling dazzled and without his pupils narrowing. This means that the light coming from the infrared light source can be focused at high intensity upon the retina of the observer for a long time. In order to avoid damage to the retina, the DE 103 48 117 A1 proposes to distribute infrared LEDs across a large area of a motor vehicle body so that its light is also distributed over the entire surface of the retina of an observer.

Such an extensive distribution of many IR-LEDs means that installation of this kind of conventional night vision system is very cumbersome and expensive.

Accordingly, it is desirable to propose a night vision system that is capable of reliably avoiding dazzling the observer without requiring a large number of infrared light sources distributed over a widespread area. In addition, other objects, desirable features and characteristics will become apparent from the subsequent summary and detailed description, and the appended claims, taken in conjunction with the accompanying drawings and this background.

### SUMMARY

In an exemplary embodiment, with an infrared light source for a motor vehicle with at least one LED assembly emitting infrared light and a sensor which is responsive in the wavelength range of the infrared light, the LED assembly is aligned so as to emit a bundled infrared beam, and in that deflecting means are provided for periodically moving the infrared beam through a predefined solid angle range.

The movement of the infrared beam ensures that this does not impact upon the eyes of an observer for any length of time. The fluctuation in the infrared intensity reflected from a given spatial direction, which is connected with the movement of the bundled infrared beam, makes it easy to differentiate between reflected infrared light and the background, so that a small light output from the LED assembly is sufficient to achieve a desired signal-noise ratio. This is another factor in contributing to avoid dazzle from the night vision system according to an embodiment.

The deflecting means may be in the form of a motor acting to rotate the entire LED assembly; however, in a preferred implementation the LED assembly may be immovably mounted on the motor vehicle, and the deflecting means has a rotating body that is arranged in the radiation path of the LED assembly in order to break the infrared beam, or a rotating mirror reflecting the infrared beam. There may be several such bodies or mirrors arranged one behind the other in the radiation path, in order to deflect the infrared beam simultaneously in two different spatial directions and thus to scan a two-dimensional solid angle range.

The body or mirror is, for example, prism-shaped.

The sensor may comprise a single sensor element responsive to infrared light from the entire predefined solid angle range. The change over time of the output signal of this sensor then reflects the infrared amount changing during the course of the movement of the infrared beam reflected back to the sensor, and it is possible to reconstruct an image of the environment from the output signal if at any point in time it is known into which direction the infrared beam is emitted. In an embodiment, the sensor comprises a one- or two-dimensional arrangement of sensor elements which directly supply a spatially resolved output signal.

Conveniently the period with which the sensor elements of the arrangement are read out is shorter than the period of movement of the infrared beam. This means that between sequential read-out points in time, only a part of the sensor elements has received reflected infrared light from the LED assembly, whilst the other sensor elements have received only natural infrared. By forming the difference between sequentially read-out data of each sensor element, the contribution of the natural infrared may be suppressed enabling the reflected infrared of the LED assembly to be recorded with high sensitivity against little background.

The majority of infrared sensors is based on semi-conductor materials and are intrinsically sensitive to photons the energy of which is greater than the band gap of the semi-conductor material. The wavelength range in which these sensors are sensitive therefore has a width of usually several hundred nanometers. In order to reduce the background signal of such a sensor, it is convenient to arrange a narrow-band filter in front of the sensor, which is permeable to the infrared beam of the LED.

In an embodiment, the LED assembly is part of a headlight. This simplifies wiring and assembly, and in addition it has the advantage that an observer when dazzled by a visible light source of the headlight, will involuntarily look away from the light or will narrow his pupils so that his retina is protected against a long-lasting exposure to infrared light coming from the direction of the headlight.

In order to guaranty the protective effect, the LED assembly, for example, is operable only in conjunction with a light source for visible light of the headlight.

In order to increase the frequency with which a given solid angle is scanned by an infrared beam—thus increasing the rate of updating the images supplied by the night vision system—the system may comprise a plurality of LED assemblies. So as to ensure that, despite limited freedom of movement of the beam emitted by a single LED assembly, a large angle range can be recorded by the night vision system, the LED assemblies may be conveniently arranged in such a way that the beams emitted by them pass over solid angle ranges which lie adjacent to each other.

### BRIEF DESCRIPTION OF THE DRAWINGS

The various embodiments will hereinafter be described in conjunction with the following drawing figures, wherein like numerals denote like elements, and wherein:

FIG. 1 shows a front view of a motor vehicle which is equipped with a night vision system according to an exemplary embodiment;

FIG. 2 shows a schematic partial section through a headlight of the vehicle in FIG. 1 according to an exemplary embodiment;

FIG. 3 shows a section analogous to FIG. 2 according to a another embodiment;

FIG. 4 shows a first image supplied by a camera of the night vision system;

FIG. 5 shows a second image supplied by the camera of the night vision system;

FIG. 6 shows an image derived from the images of FIGS. 4 and 5 presented to the driver of the vehicle on a display screen; and

FIG. 7 shows a section analogous to FIG. 2 according to a further embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

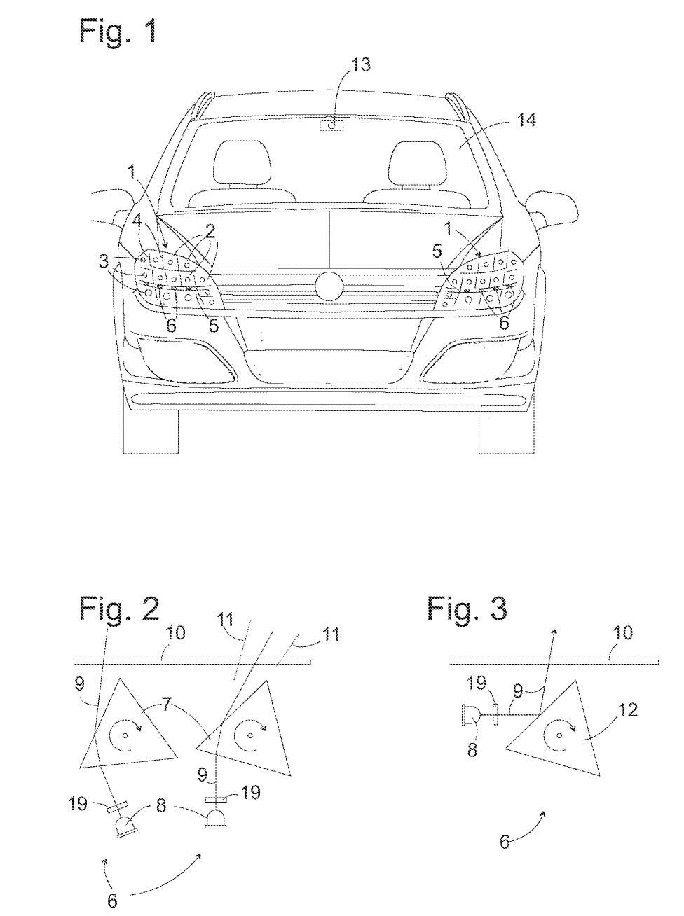

In accordance with an exemplary embodiment, FIG. 1 shows a frontal view of a motor vehicle equipped with front headlights based on LEDs. Each of the front headlights 1 is composed of a plurality of stationary units 2 each comprising a reflector 3 and, at the bottom of the reflector, an assembly with several LEDs or a single high-power LED 4 emitting visible white or colored light depending upon the application. Several of the units 2 are respectively grouped together by a common control to form a functional group composed e.g. of an indicator, a dipped beam, a full beam etc.

Between the units 2 of the full beam essentially occupying an upper part of the headlight, and those of the dipped beam in the lower area of the headlight 1 there is a zone 5 in which respectively several LED assemblies 6 are arranged, which in the coordinate system of the vehicle emit movable infrared beams. Two such LED assemblies according to an embodiment are shown in FIG. 2 in a schematic section. They comprise, respectively, a prism 7 driven by a motor, not shown, in a rotating movement about an axis vertical to the sectional plane as well as an IR-emitting LED 8, a beam 9 of which is broken in the prism 7 arranged respectively between the LED 8 and an external disc 10 of the headlight 1 and deflected. Cylindrical lenses 19 are arranged in vertical direction from the LEDs 8 for fanning out the beams 9. The LED may be incoherently emitting, but it is also possible to use a laser diode. Modern laser diodes offer the possibility of achieving very high luminance values. Since, in addition, they provide a narrowly bundled beam with little divergence, the dimensions of the prism 7 can be kept small which makes it easier to accommodate the headlights.

The azimuthal direction into which the prism 7 deflects the beam 9 varies with the rotation of the prism 7 so that each beam 9 swings back and forth in an angle interval such as marked by dotted lines 11 in FIG. 2 in the case of the right-hand LED 8. The orientation of the LED 8 adjacent to the left-hand side is turned in relation to the right-hand LED 8 such that the angle intervals passed over by their beams 9 after passing through the prisms 7 are touching each other or slightly overlap each other. By mounting a sufficiently large number of differently orientated LEDs 8 in the zone 5, the azimuthal angle range scanned by their beams 9 can be given a randomly large size.

In another embodiment, instead of a rotating prism, a rotating mirror 12 may be used, as shown in FIG. 3, in order to deflect the beam 9 of the LED 8. Since the LED 8 must be mounted here laterally of the mirror 12, a single LED-LED-assembly 6 here occupies more space along the surface of the external disc 10 than in the implementation of FIG. 2. This disadvantage is, however, compensated for by the fact that the angle range passed over by a single beam 9 can be made bigger than in the case of a prism 7 operated in transmission so that the number of LED assemblies 6 required for covering a given solid angle range in front of the vehicle is smaller than in the implementation of FIG. 2. Besides the beam 9 moves outside the headlight with a consistent angle speed, i.e. double the angle speed of the mirror 12 and abruptly jumps back to the opposite edge when it has reached an edge of its angle range, so that irregularities in the illumination are avoided which in the case of the prism are due to a variable angle speed of the beam 9.

The prism 7 and the mirror 12 are shown in FIGS. 1 and 2 respectively with a triangular cross-section, but it is understood that other polygonal cross-sections can be considered.

In an embodiment, the light of the LEDs 8 reflected from objects in front of the vehicle reaches a camera 13 which as shown in FIG. 1 may be attached inside a front screen 14 of the passenger compartment, for example, centrally in the vicinity of the upper edge of the front screen 14 and which is aligned with the carriageway in front of the vehicle. The camera 13 contains an arrangement implemented as an optical sensor, which is a two-dimensional arrangement of sensor elements known as such, e.g. a CCD device which is intrinsically sensitive to visible light and light in the near infrared range with wavelengths of up to approx. 1 μm. In order to render the sensor insensitive to visible light, in an embodiment, a filter transparent to infrared but impermeable to visible light is arranged in front of the sensor. In order to make the camera 13 as insensitive as possible to natural infrared radiation, the filter may be a narrowband filter with a transmission band width tuned exactly to the emission spectrum of the LEDs 8, in order to allow as much as possible of the light from the LEDs 8 through, but to block infrared with wavelengths which are not part of the spectrum of the LEDs 8.

The filter may be movable in order to be able to use the camera 13 also for other traffic space monitoring purposes, in particular if, because of sufficient brightness in the environment, the headlights 1 and also the LEDs 8 as part thereof are switched off and the night vision system is not needed.

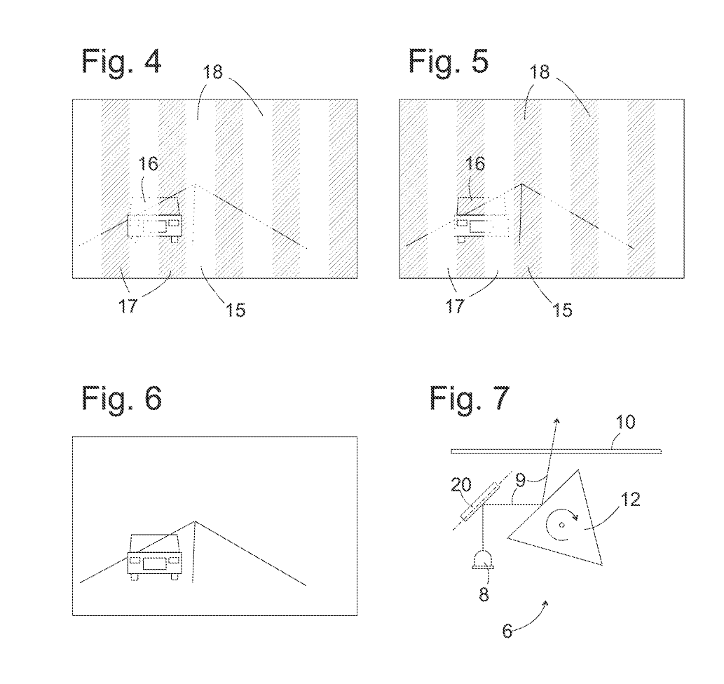

FIG. 4 schematically shows an image taken by the camera 13 at a given point in time of a two-lane road 15 in front of the vehicle. The opposite lane shows a vehicle 16 approaching. The time span in which the camera 13 collects the light for the image of FIG. 4 and integrates it is shorter than the movement period of the beams 9, in this case here about half as long. As a result the image supplied by the camera 13 disintegrates into a plurality of zones 17, 18 alternating from left to right. The zones 17 are formed by those solid angle ranges, which during the collecting period were passed over by a beam 9, whereas the zones 18 have remained non-illuminated. In the zones 17 the image of the camera is thus based on the reflected light from the LEDs 8 as well as on the natural infrared of the scenery observed, whilst the image obtained in the zones 18 is indistinct, based solely on the natural infrared.

During a subsequent integration period the beams 9 pass over the previously non-illuminated zones 18, whilst the zones 17 illuminated in the previous integration period remain in the dark. The image obtained and shown in FIG. 5 therefore is rich in detail exactly in those zones 18, which in the image in FIG. 4 contain hardly recognizable structures, and vice versa.

The images of FIGS. 4 and 5 can be combined to form a complete image by calculating the amount of difference of the luminance values of the images of FIGS. 4 and 5 for each pixel. Since the contribution of the natural infrared radiation in the images of FIGS. 4 and 5 is the same, it is suppressed in the image calculated, and only those objects of the scenery become visible which are impacted upon by the beams 9. As a result the vehicle 16 is clearly visible as a whole in the image of FIG. 6, but parts of the vehicle 16, which in themselves emit strong infrared radiation, such as the headlights, do not outshine the structures which become visible in the light of the LEDs 8.

The vertical extension of the illuminated zone 17 is due to the vertical fanning out of beams 9 by the cylindrical lenses 19 in the LED assemblies 6 of FIG. 2 or 3. FIG. 7 shows an implementation of a LED assembly 6, in which, in an embodiment, the cylindrical lens is replaced by a mirror 20 which is pivotable about an axis extending in the sectional plane with a period, which is an integer multiple of the azimuthal deflecting period of the mirror 12. The movement of the mirror 20 allows the point at which the beams impacts upon the mirror 12 to wander in the vertical, so that the beam 9 scans the environment row for row like the electron beam of a picture tube. When such an LED assembly is used, it is possible for the camera 13 to capture images, which like images of FIGS. 4 and 5, are composed of illuminated and non-illuminated zones and can be combined to obtain an image which has been cleaned of the contribution of the natural infrared radiation.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A night vision system for a motor vehicle comprising;
an infrared-light-emitting LED assembly adapted to emit a bundled infrared beam and comprising a deflecting means for periodically moving the infrared beam through a predefined solid angle range; and
a sensor responsive in a wavelength range of the infrared beam.

2. The night vision system according to claim 1, wherein the deflecting means comprises a rotating body adapted to break the infrared beam or comprises a rotating mirror.

3. The night vision system according to claim 2, wherein the rotating body or the rotating mirror is prism-shaped.

4. The night vision system according to claim 1, wherein the sensor comprises a one- or two-dimensional arrangement of sensor elements.

5. The night vision system according to claim 4, wherein a period with which the sensor elements are read, is shorter than a period of movement of the infrared beam.

6. The night vision system according to claim 1, wherein the sensor is preceded by a permeable filter which is narrowband for the infrared beam of the infrared-light-emitting LED assembly.

7. The night vision system according to claim 1, wherein the infrared-light-emitting LED assembly is part of a headlight.

8. The night vision system according to claim 7, wherein the infrared-light-emitting LED assembly is operated in conjunction with a light source for visible light.

9. The night vision system according to claim 1, wherein the infrared-light-emitting LED assembly comprises a laser diode.

10. The night vision system according to claim 1, wherein the night vision system comprises a plurality of infrared-light-emitting LED assemblies, which emit beams moved through adjacent solid angle ranges.
